(19) United States
(12) Patent Application Publication
(10) Pub. No.: US 2020/0343652 A1
(43) Pub. Date: Oct. 29, 2020

(54) JOINED SUPERCONDUCTING TAPE

(71) Applicant: BASF SE, Ludwigshafen am Rhein (DE)

(72) Inventors: Martina FALTER, Rheinbach (DE); Michael BAECKER, Rheinbach (DE)

(73) Assignee: BASF SE, Ludwigshafen am Rhein (DE)

(21) Appl. No.: 16/763,823

(22) PCT Filed: Nov. 19, 2018
(86) PCT No.: PCT/EP2018/081682

§ 371 Date: May 13, 2020

(30) Foreign Application Priority Data
Nov. 28, 2017 (EP) 17204144.4

(51) Int. Cl. H01R 4/68; H01B 12/06; H01R 43/02

(52) U.S. Cl. CPC H01R 4/68; H01R 43/02; H01B 12/06

(57) ABSTRACT

Superconducting articles are disclosed which comprise at least two superconducting tapes (10, 20), each tape comprising a stabilizer layer (15, 25), a superconductor layer (13, 23), and a buffer layer (12, 22) formed in that order on a substrate (11, 21), and at least one metal tape (1) attached to the superconducting tapes via a solder layer (2) along at least twice the length of a joint region where the two superconducting tapes overlap or are overlapped by a bridge (30).

The present invention is in the field of joined superconducting tapes.

High-temperature superconductors in tape form are typically produced by epitaxial deposition on flexible metal substrates, e.g. nickel, nickel alloys or stainless steel. For many applications, e.g. cables, very long tapes in the kilometer range are required. However, it is very difficult to produce so long tapes in one piece. A practical solution is to produce shorter tapes and join them together.

WO 01/08233 A2 discloses a typical joint of tapes. Two tapes are soldered together via a metal layer which is often referred to as stabilizer layer because it acts to stabilize the tape in case the superconductivity breaks down by conducting the electricity and thereby avoids uncontrolled flashover. However, when the superconductor is in its normal superconducting operation mode, such a joint adds quite some resistance to the joined tape because stabilizer layers have to have a certain thickness to be effective. Various variations of joints are known, for example from WO 2010/011739 A1 or WO 2012/037231 A1. However, they all suffer from relatively high contact resistance between two joined tapes.

Attempts to attach two tapes directly via their superconductor layers have failed because the superconductors typically used, such as YBa₂Cu₃O₇₋ₓ, are very sensitive towards contact with flux used for soldering or they do not wet at all with molten metals or alloys used as solder. It was therefore an object of the present invention to provide a joint which has a low contact resistance while the tape is sufficiently stabilized and the superconductor performance of a tape is not compromised by the joint. A further object was to provide a joint which is mechanically stronger, in particular against forces occurring during winding of coils.

These objects were achieved by a superconducting article comprising two superconducting tapes each comprising a substrate, a buffer layer, a superconductor layer, and a stabilizer layer, wherein the buffer layer and the superconductor layer are between the substrate and the stabilizer layer, and wherein the superconducting article further comprises at least one metal tape which is attached to both superconducting tapes via a solder layer along at least twice the length of the joint region.

The present invention further relates to a process for making a superconducting article comprising laminating a metal tape to two superconducting tapes each comprising a substrate, a buffer layer, a superconductor layer, and a stabilizer layer, wherein the buffer layer and the superconductor layer are between the substrate and the stabilizer layer, wherein the metal tape is attached to both superconducting tapes via a solder layer along at least twice the length of the joint region.

Preferred embodiments of the present invention can be found in the description and the claims. Combinations of different embodiments fall within the scope of the present invention.

The superconducting article according to the present invention comprises superconducting tapes. A superconducting tape comprises a substrate. The substrate may be formed of any material capable of supporting buffer and/or superconducting layers. For example, suitable substrates are disclosed in EP 830 218, EP 1 208 244, EP 1 198 846, and EP 2 137 330. Often, the substrate is a metal and/or alloy strip/tape, whereby the metal may be or the alloy may contain nickel, silver, copper, zinc, aluminum, iron, chromium, vanadium, palladium, molybdenum, tungsten. Preferably the substrate is nickel based, which means that at least 50 at-% of the substrate is nickel, more preferably at least 70 at-%, in particular at least 85 at-%. Sometimes, some of these alloys are referred to by the trade name Hastelloy®. More preferably, the substrate is nickel based and contains 1 to 10 at-%, in particular 3 to 9 at-%, tungsten. Laminated metal tapes, tapes coated with a second metal like galvanic coating or any other multi-material tape with a suitable surface can also be used as substrate.

The substrate can be non-textured, partially textured or textured, preferably it is textured. In case the substrate is partially textured, preferably its surface is textured. The substrates are typically 20 to 200 μm thick, preferably 30 to 100 μm. The length is typically 1 to 1000 m, for example 100 m, the width is typically 0.4 cm to 1 m. The ratio of length to width is typically at least 100, preferably at least 200, in particular at least 500.

Preferably the substrate has a surface of low roughness. For this reason, surface is preferably planarized, for example by electropolishing. It is often advantageous to subject the thus planarized substrate to a thermal treatment. This thermal treatment includes heating the substrate to 600 to 1000° C. for 2 to 15 minutes, wherein the time refers to the time during which the substrate is at the maximum temperature. Preferably, the thermal treatment is done under reducing atmosphere such as a hydrogen-containing atmosphere. The planarization and/or thermal treatment may be repeated.

Preferably, the surface of the substrate has a roughness with rms according to DIN EN ISO 4287 and 4288 of less than 15 nm. The roughness refers to an area of 10×10 ∥m within the boundaries of a crystallite grain of the substrate surface, so that the grain boundaries of the metal substrate do not influence the specified roughness measurement.

The superconducting tape according to the present invention further comprises a buffer layer. The buffer layer can contain any material capable of supporting the superconductor layer. Examples of buffer layer materials include metals and metal oxides, such as silver, nickel, TbOₓ, GaOₓ, CeO₂, yttria-stabilized zirconia (YSZ), Y₂O₃, LaAlO₃, SrTiO₃, Gd₂O₃, LaNiO₃, LaCuO₃, SrRuO₃, NdGaO₃, NdAlO₃ and/or some nitrides as known to those skilled in the art. Preferred buffer layer materials are yttrium-stabilized zirconium oxide (YSZ); zirconates, such as gadolinium zirconate, lanthanum zirconate; titanates, such as strontium titanate; and simple oxides, such as cerium oxide, or magnesium oxide. More preferably the buffer layer contains lanthanum zirconate, cerium oxide, yttrium oxide, magnesium oxide, strontium titanate and/or rare-earth-metal-doped cerium oxide such as gadolinium-doped cerium oxide. Even more preferably the buffer layer contains lanthanum zirconate and/or cerium oxide. The surface of the buffer layer is preferably textured. The lattice parameters of the textured part of the buffer layer resemble the lattice parameters of the superconductor layer showing only a small mismatch to the lattice constant.

To enhance the degree of texture transfer and/or the efficiency as diffusion barrier, the super-conducting tape preferably contains more than one buffer layer on top of each other. Preferably the superconducting tape comprises two or three buffer layers, for example a first buffer layer comprising lanthanum zirconate and a second buffer layer containing cerium oxide.

The buffer layer preferably covers the whole surface of the substrate on one side, which means at least 95% of the surface, more preferably at least 99% of the surface. The buffer layer typically has a thickness of 5 to 500 nm, for example 10 to 30 nm or 150 to 300 nm.

The buffer layer can be made in various ways including physical deposition, such as ion beam assisted deposition (IBAD) or laser deposition, or by chemical solution deposition. If the buffer layer is made by chemical solution deposition, the buffer layer is often made in several steps such that it contains several individual layers of the same chemical composition, for example three layers of each 100 nm. Such a process is for example described in WO 2006/015 819 A1. The buffer layer preferably has a low surface roughness, for example an rms according to DIN EN ISO 4287 and 4288 of less than 50 nm or even less than 30 nm.

The superconducting tape according to the present invention further comprises a superconductor layer. Preferably, the superconductor layer contains a compound of the formula REₓBa_{y}Cu₃O_{7-δ}. RE stands for one or more than one rare earth metal, preferably yttrium, dysprosium, holmium, erbium, gadolinium, europium, samarium, neodymium, praseodymium, or lanthanum, in particular yttrium. An example, in which RE stands for more than one rare earth metals is RE=Y_{0.9}Gd_{0.1}. The index x assumes a value of 0.9 to 1.8, preferably 1.2 to 1.5. The index y assumes a value of 1.4 to 2.2, preferably 1.5 to 1.9. The index δ assumes a value of 0.1 to 1.0, preferably 0.2 to 0.5. The superconductor layer preferably has a thickness of 200 nm to 5 μm, more preferably 400 nm to 3.5 μm, for example 1 to 2 μm. Preferably, the superconductor layer has crystal grains with a high degree of orientation to each other. If the superconductor layer is made by chemical solution deposition, it is often made in several steps such that it contains several individual layers of the same chemical composition, for example three layers of each 100 nm. Such a process is for example described in WO 2016/150 781 A1.

The superconductor layer preferably further contains non-conductive particles which act as pinning centers and can minimize the critical current density loss upon application of magnetic fields. Typical pinning centers contain ZrO₂, stabilized ZrO₂, HfO₂, BaZrO₃, Ln₂Zr₂O₇, CeO₂, BaCeO₃, Y₂O₃ or RE₂O₃, in which RE stand for one or more rare earth metals. Usually, the particles have an average diameter of 1 to 100 nm, preferably 2 to 20 nm.

The superconducting layer preferably has a low surface roughness, for example an rms according to DIN EN ISO 4287 and 4288 of less than 100 nm or even less than 50 nm. The superconducting layer typically has a resistance close to zero at low temperatures, preferably up to a temperature of at least 77 K. Preferably, the superconductor layer has a critical current density without externally applied magnetic field of at least 1·10⁶ A/cm², more preferably at least 1.5·10⁶ A/cm². Preferably, the critical current density decreases by less than 30% if a magnetic field of 0.1 T is applied perpendicular to the surface of the superconductor layer, more preferably it decreases by less than 20%. Preferably, the critical current density decreases by less than 15% if a magnetic field of 0.1 T is applied parallel to the surface of the superconductor layer, more preferably it decreases by less than 10%.

The superconducting layer can be made in various ways, including physical vapor deposition methods such as pulsed laser deposition (PLD), sputtering or coevaporation; or chemical solution deposition (CSD). Often, in particular if the superconductor layer is made by CSD, fluorine containing precursors, such as BaF₂ or Ba(TFA)₂, wherein TFA stands for trifluoroacetate, are used in these processes. In this case, the superconducting layer often contains trace amounts of residual fluorine, for example 10⁻¹⁰ to 10⁻⁵ at-%.

The superconducting tape according to the present invention further comprises a stabilizer layer. The stabilizer layer typically has a low electrical resistance, preferably lower than 1 μΩm at room temperature, more preferably lower than 0.2 μΩm at room temperature, in particular lower than 0.05 μΩm at room temperature. Often, the stabilizer layer comprises a metal, preferably copper, silver, tin, zinc or an alloy containing one of these, in particular copper. Preferably, the stabilizer layer contains at least 50 at-% copper, tin or zinc, more preferably at least 70 at-%, in particular at least 85 at-%. Preferably, the stabilizer layer has a thickness of 0.1 to 50 μm, more preferably 0.5 to 20 μm, in particular 1 to 10 μm.

The stabilizer layer can be made in various ways including physical vapor deposition, chemical solution deposition, sputtering, electrodeposition, or lamination. Electrodeposition is preferred which means that the stabilizer layer is preferably an electrodeposited layer, more preferably the stabilizer layer is an electrodeposited layer on a noble metal layer. Electrodeposition of a stabilizer layer is for example described in WO 2007/032 207 A1.

The stabilizer layer can just overlie the superconducting layer. Preferably, the stabilizer layer covers the whole circumference of the tape, i.e. it overlies the superconducting layer, the substrate and at least two of the side surfaces. It is possible that the stabilizer layer has a different thickness on the different sides of the tape or the same. If the thickness is different, the thickness ranges above refer to the side with the highest thickness. In particular if the stabilizer layer is a galvanized layer, the so called “dog-bone” effect often leads to higher thicknesses at the edges compared to flat areas.

Preferably, the superconducting tape further contains a noble metal comprising layer in between the superconductor layer and the stabilizer layer. Such a layer avoids the degradation of the superconductor layer when the stabilizer layer is deposited. It also increases the conductivity of the tape for the deposition of the stabilizer layer, which is particularly relevant if electrodeposition is used. Typically, the noble metal comprising layer contains silver. A method of making a noble metal comprising layer on a superconducting layer is disclosed for example in WO 2008/000 485 A1.

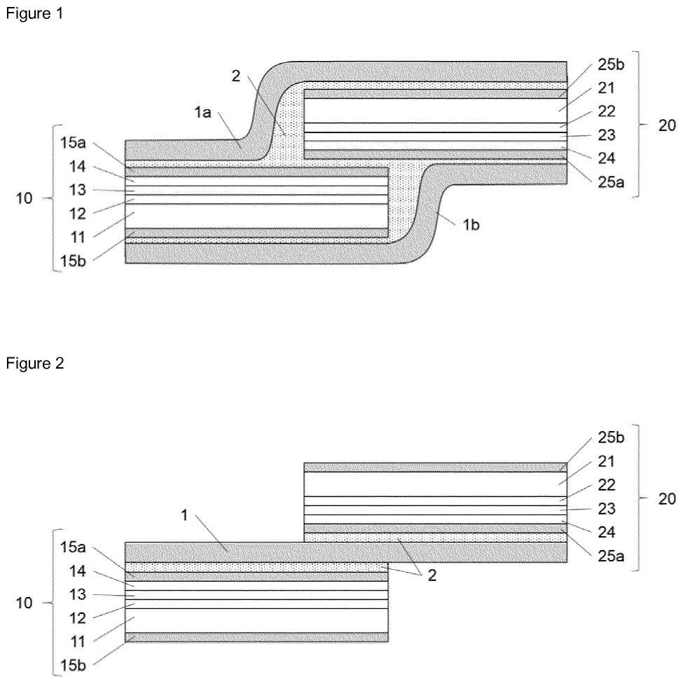

The two superconducting tapes in the superconducting article are typically in close contact to each other, preferably such that the superconducting layers are in close proximity to each other. This can be achieved for example by overlapping the two tapes along a small fraction of their length, often less than 0.2%, bringing in close contact to each other the surfaces of the tape which are parallel to the superconducting layer and have the shortest distance to the superconducting layer as for example shown in FIG. 1.

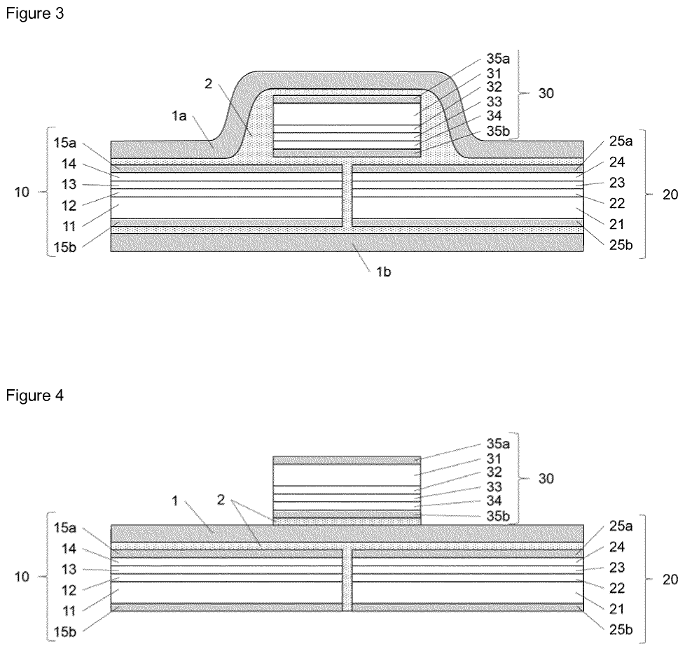

Alternatively, the two superconducting tapes can be arranged such that their smallest side surfaces face each other and either stand at least in part in contact to each other or are separated by a small gap, wherein the width of the gap is preferably less than the width of the superconductor tapes. Preferably the orientation of the substrate, buffer, superconducting and stabilizer layer in the two superconducting tape is the same, for example as shown in FIGS. 3 and 4. In this case it is usually necessary to add a bridge to the superconducting article which bridges the gap between the two superconducting tapes. The bridge is a short piece of high conductivity, for example a silver tape, or preferably another superconducting tape. If the bridge is a superconducting tape, it can have the same composition and thickness as the superconducting tapes or different to each other. For example, the superconducting tape acting as bridge can lack a stabilizer layer or it can be thinner and/or narrower than the two superconducting tapes which are joined. A connecting structure containing two superconducting tapes and a bridge is often referred to as splice.

It can be useful to first provisionally connect the two superconducting tapes via an auxiliary tape to hold them in place for the following lamination process. In this case, the superconducting article preferably further comprises an auxiliary tape attached to the two superconducting tapes, in particular attached to the side of the superconducting tapes which are closer to their substrates. There is no particular requirement for the auxiliary tape other than enough mechanical stability during the subsequent lamination processes, so the auxiliary tape can be a metal tape such as steel, nickel, aluminum; or a heat-resistant polymer strip such as polyamide. The auxiliary tape can be connected in various ways such as soldering or gluing. The width of the auxiliary tape is preferably the same or smaller than the width of the superconducting tapes.

The smallest sides of the superconducting tapes form an angle a with the length of the tape as for example shown in FIG. 6, where a top view on the two superconducting tapes 10 and 20 is depicted. Usually, the angle α is 90° or approximately 90°. However, if the smallest side surfaces of the two superconducting tapes are in contact to each other, the angle α is preferably lower than 90°, for example 20° to 80°, more preferably 30° to 70°, for example 45°. In this way, the joint is mechanically more stable and the resistance over the joint between the two super-conducting tapes is lower.

The two superconducting tapes are preferably attached to each other by a solder. Preferably, the superconducting tapes are attached to each other such that the shortest path between the superconducting layer of the first superconducting tape and the superconducting layer of the second superconducting tape contains not more than two stabilizer layers and a solder layer. Preferably, the shortest path between the superconducting layer of the first superconducting tape and the superconducting layer of the second superconducting tape is less than 60 μm, more preferably less than 40 μm, in particular less than 30 μm, for example less than 25 μm.

The superconducting article according to the present invention further comprises at least one metal tape which is attached to both superconducting tapes. The two superconducting tapes can be attached to the same side of the metal tape or they can be attached to opposite sides of the metal tape. According to the invention the metal tape is attached to both superconducting tapes along at least twice the length of the joint region, preferably at least five times the length of the joint region, in particular at least ten times. The joint region is the part of the superconducting article where the two superconducting tapes overlap or are overlapped by a bridge. Particularly preferably, the metal tape extends along the whole length of the superconducting article.

Metal in the context of the present invention refers to any material which contains at least one metal element and has metallic electrical conductivity, i.e. at least 10⁵ S/m at room temperature. The metal tape can contain various metals, preferably copper, nickel, chromium, zinc, aluminum, magnesium, tin, or alloys thereof, for example brass, bronze, or stainless steel. It is possible that the metal tape has a homogeneous composition or it has a layered structure of different metal compositions. Gradients in the composition are also conceivable.

The metal tape preferably has a thickness of 10 to 1000 μm, more preferably 20 to 500 μm, in particular 50 to 300 μm. The metal tape preferably has a length of 5 cm to 100 km, more preferably 10 m to 10 km, for example 500 m or 1 km. Preferably, the length of the metal tape is greater than the length of a superconductor tape, more preferably the length of the metal tape is greater than 1.5 times the length of a superconductor tape. The width of the metal tape can be the same as the superconducting tapes or it can be wider or narrower. The metal tape preferably has a thickness of 20 μm to 500 μm, more preferably 30 to 400 μm, in particular 50 to 300 μm.

It is possible that the metal tape overlies just one side of the superconducting tapes or it is bent around the two superconducting tapes overlying the whole circumference of the superconducting tapes or the major part of the circumference, for example more than 80%. Preferably, the superconducting article comprises two metal tapes. More preferably, the superconducting article comprises two metal tapes on opposite sides of the superconducting tapes. In particular, the superconducting article comprises two metal tapes on opposite sides of the superconducting tapes extending beyond the width of the superconducting tapes.

According to the present invention, the at least one metal tape is attached to the two superconducting tapes via a solder layer. Typical solder materials can be used, preferably tin or indium alloys such as Sn—Pb, Sn—Ag, Sn—Cu, Sn—Bi, Sn—Ag—Cu, Sn—Ag—Bi, In—Sn, In—Ag, In—Pb, In—Pb—Ag. Examples are 60% Sn-40% Pb or 52% In-48% Sn. The melting point of the solder is preferably not more than 300° C., in particular not more than 250° C. The solder layer between the metal tape and the superconducting tape preferably has an average thickness of 0.1 to 5 μm, wherein any solder potentially extending beyond the side of the metal tape and the superconductor tape is not taken into account for the thickness calculation. Preferably, the solder attaching the metal tape to the superconducting tapes has a higher melting point than the solder attaching the two superconducting tapes to each other.

Preferably, the superconducting article further comprises a support piece between the superconducting tape and the metal tape to support the metal tape at edges, for example in the corner formed by two superconductor tapes stacked on top of each other. The support piece reduces the punctual stress on the metal tape at edges, for example during the lamination process of the metal tape or during later processing of the superconductor article, and provides an increased mechanical strength of the joint region. Preferably, the support piece has a shape resembling the space between metal tape and the superconductor tapes which is usually filled with solder, in particular the support piece has the shape of a triangular prism. Preferably, the support piece extends along the whole or substantially the whole width of the superconductor article. The support piece can be of any material which is resistant to liquid solder, for example temperature-resistant polymers or metals.

The advantage of having a stabilizer layer in each superconducting tape and at least a metal tape attached to both superconducting tapes is a decreased electrical contact resistance and an increased mechanical stability of the joint in comparison to traditional joints. Preferably, the electrical contact resistance between the two superconductor tapes in the superconductor article measured at 77 K is 100 nΩcm² or less, more preferably 70 nΩcm² or less, in particular 50 nΩcm² or less. In addition, the thickness of the superconducting article at the joint is less than twice the thickness of the superconducting article outside the joint region. In a coil for example, it is easier to wind regular pattern as the joints can be regarded as defects in a coil. In traditional joints, this thickness ratio is two or even higher taking into account the thickness of the solder layer.

FIGS. 1 to 5 show preferred embodiments of the present invention. In FIG. 1, a joint between a first and a second superconducting tape 10 and 20 which are contacted in reverse orientation to minimize the distance between their superconductor layers is shown. The superconducting tapes 10 and 20 have a substrate 11 and 21, a buffer layer 12 and 22, a superconductor layer 13 and 23, a noble metal layer 14 and 24 and a stabilizer layer which surrounds the circumference of the superconductor tape and where the upper part 15a and 25a and the lower part 15b and 25b are depicted. The two superconductor tapes 10 and 20 are attached to each other via a solder layer 2. The joint is laminated with two metal tapes 1a and 1b both attached to both superconductor tapes 10 and 20 via the solder layer 2.

FIG. 2 shows an alternative to the embodiment of FIG. 1 in which the first and the second superconducting tape 10 and 20 are attached to one metal tape 1 via the solder layer 2 on opposite sides of the metal tape 1.

FIG. 3 shows a joint of two superconductor tapes 10 and 20 which are connected to a bridge 30 via a solder layer 2. The bridge 30 is a short superconductor tape having a substrate 31, a buffer layer 32, a superconductor layer 33, a noble metal layer 34 and a stabilizer layer which surrounds the circumference of the bridge 30 and where the upper part 35a and the lower part 35b are depicted. The metal tape 1b overlies the two superconducting tapes 10 and 20 on one side, the metal tape 1a overlies the two superconducting tapes 10 and 20 and the bridge 30 on the other side.

FIG. 4 shows a joint of two superconductor tapes 10 and 20 with the metal tapes 1 overlying the two superconducting tapes 10 and 20. In contrast to FIG. 3, the metal tape 1 does not overly the bridge 30, but the bridge 30 is placed on the other side of metal tape 1 than the two superconductor tapes 10 and 20.

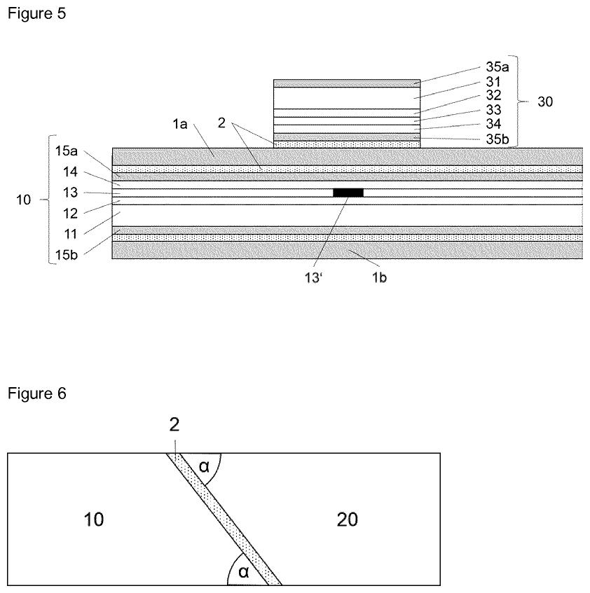

FIG. 5 shows an alternative use of the present invention in the bridging of defects in superconducting tapes. The superconducting tape 10 has a defect 13′ in its superconducting layer 13. The defect 13′ is not superconductive, for example because there is a local misorientation of the crystals, a wrong chemical composition, or simply a local crack or scratch. These defects are often insulating rendering the whole tape useless. Sometimes they are not detected before the superconducting tape has been laminated with a metal tape By soldering a bridge 30 over the defect, the electrical current has an alternative flow path which largely recovers the superconductivity of the tape.

1. A superconducting article, comprising:
two superconducting tapes each comprising:
a substrate;
a buffer layer;
a superconductor layer; and
a stabilizer layer;
wherein the buffer layer and the superconductor layer are between the substrate and the stabilizer layer, and
at least one metal tape which is attached to both superconducting tapes via a solder layer,
wherein the at least one metal tape is attached along at least twice the length of the a joint region.

2. The superconducting article according to claim 1, wherein the superconducting article comprises at least two metal tapes which are attached to both superconducting tapes via a solder layer on opposite sides of both superconducting tapes.

3. The superconducting article according to claim 1, wherein the shortest path between the superconducting layer of the first superconducting tape and the superconducting layer of the second superconducting tape is less than 60 μm

4. The superconducting article according to any of the claim 1, wherein the two superconducting tapes each further comprise a smallest side, and
wherein for each superconducting tape, the smallest side forms an angle of 20° to 80° with the length of the superconducting tape.

5. The superconducting article according to claim 1 to wherein the each stabilizer layer has a thickness of 0.1 to 20 μm.

6. The superconducting article according to claim 1, wherein the each stabilizer layer is a galvanized layer.

7. The superconducting article according to claim 1, wherein the at least one metal tape is attached to each superconducting tape along at least five times the length of the joint region.

8. The superconducting article according to claim 1, wherein the two superconducting tapes are attached to each other via a first solder layer comprising a first solder, and
wherein the solder layer attaching the at least one metal tape to both superconducting tapes comprises a second solder, and
wherein the first solder has a higher melting point than the second solder.

9. The superconducting article according to claim 1, wherein the at least one metal tape comprises at least one selected from the group consisting of copper, brass, stainless steel, nickel, chromium, zinc, aluminum, magnesium, and tin.

10. The superconducting article according to claim 1, wherein the at least one metal tape has a thickness of 20 to 500 μm.

11. The superconducting article according to claim 1, wherein the two superconducting tapes are bridged via a third superconducting tape.

12. The superconducting article according to claim 11, wherein the two superconducting tapes are placed on one side of the at least one metal tap; and
wherein the third superconducting tape is placed on the other side of the at least one metal tape.

13. The superconducting article according to claim 11, wherein a thickness and/or a width of the third superconducting tape is lower than that of each of the two superconducting tapes.

14. A process for making a superconducting article, the method comprising:
laminating a metal tape to two superconducting tapes, each superconducting tape comprising:
a substrate;
a buffer layer;
a superconductor layer; and
a stabilizer layer,
wherein the buffer layer and the superconductor layer are between the substrate and the stabilizer layer, and
wherein the metal tape is attached to both superconducting tapes via a solder layer,. the metal tape attached along at least twice the length of a joint region.
